(19) United States
(12) Patent Application Publication
(10) Pub. No.: US 2007/0180156 A1
(43) Pub. Date: Aug. 2, 2007

(54) Method for completing IO commands after an IO translation miss

(75) Inventors: John D. Irish, Rochester, MN (US); Chad B. McBride, Rochester, MN (US); Ibrahim A. Ouda, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/344,908

(22) Filed: Feb. 1, 2006

(51) Int. Cl. G06F 3/00

(52) U.S. Cl. 710/5

(57) ABSTRACT

Embodiments of the present invention provide methods and systems for maintaining command order while processing commands in a command queue while handling translation cache misses. Commands may be queued in an input command queue at the CPU. During address translation for a command, subsequent commands may be processed to increase efficiency. Processed commands may be placed in an output queue and sent to the CPU in order. During address translation, if a translation cache miss occurs the relevant translation cache entries may be retrieved from memory. After the relevant entries are retrieved a notification may be sent requesting reissue of the command getting the translation cache miss.

### CROSS-REFERENCE TO RELATED APPLICATIONS

This application is related to U.S. patent application Ser. No. ______, Attorney Docket No. ROC920050457US1, entitled METHOD FOR CACHE HIT UNDER MISS COLLISION HANDLING, filed Feb. _{—}, 2006, by John D. Irish et al. and U.S. patent application Ser. No. ______, Attorney Docket No. ROC920050463US1, entitled METHOD FOR COMMAND LIST ORDERING AFTER MULTIPLE CACHE MISSES, filed Feb. _{—}, 2006, by John D. Irish et al. The related patent applications are herein incorporated by reference in entirety.

### BACKGROUND OF THE INVENTION

1. Field of the Invention

The present invention generally relates to processing commands in a command queue. More specifically, the invention relates to reprocessing of commands getting address translation cache misses after retrieving address translation entries from memory.

2. Description of the Related Art

Computing systems usually include one or more central processing units (CPUs) communicably coupled to memory and input/output (IO) devices. The memory may be random access memory (RAM) containing one or more programs and data necessary for the computations performed by the computer. For example, the memory may contain a program for encrypting data along with the data to be encrypted. The IO devices may include video cards, sound cards, graphics processing units, and the like configured to issue commands and receive responses from the CPU.

The CPU(s) may interpret and execute one or more commands received from the memory or IO devices. For example, the system may receive a request to add two numbers. The CPU may execute a sequence of commands of a program (in memory) containing the logic to add two numbers. The CPU may also receive user input from an input device entering the two numbers to be added. At the end of the computation, the CPU may display the result on an output device, such as a display screen.

Because sending the next command from a device after processing a previous command may take a long time, during which a CPU may have to remain idle, multiple commands from a device may be queued in a command queue at the CPU. Therefore, the CPU will have fast access to the next command after the processing of a previous command. The CPU may be required to execute the commands in a given order because of dependencies between the commands. Therefore, the commands may be placed in the queue and processed in a first in first out (FIFO) order to ensure that dependent commands are executed in the proper order. For example, if a read operation at a memory location follows a write operation to that memory location, the write operation must be performed first to ensure that the correct data is read during the read operation. Therefore the commands originating from the same I/O device may be processed by the CPU in the order in which they were received, while commands from different devices may be processed out of order.

The commands received by the CPU may be broadly classified as (a) commands requiring address translation and (b) commands without addresses. Commands without addresses may include interrupts and synchronization instructions such as the PowerPC eieio (Enforce In-order Execution of Input/Output) instructions. An interrupt command may be a command from a device to the CPU requesting the CPU to set aside what it is doing to do something else. An eieio operation may be issued to prevent subsequent commands from being processed until all commands preceding the eieio command have been processed. Because there are no addresses associated with these commands, they may not require address translation.

Commands requiring address translation include read commands and write commands. A read command may include an address of the location of the data to be read. Similarly, a write command may include an address for the location where data is to be written. Because the address provided in the command may be a virtual address, the address may require translation to an actual physical location in memory before performing the read or write.

Address translation may require looking up a segment table and/or a page table to match a virtual address with a physical address. For recently targeted addresses, the page table and segment table entries may be retained in a cache for fast and efficient access. However, even with fast and efficient access through caches, subsequent commands may be stalled in the pipeline during address translation. One solution to this problem is to process subsequent commands in the command queue during address translation. However, command order must still be retained for commands from the same IO device.

If, during translation, no table entry translating a virtual address to a physical address is found in the cache, the entry may have to be fetched from memory. Fetching entries when there are translation cache misses may result in a substantial latency. When a translation cache miss occurs for a command, address translation for subsequent commands may still continue. However, only one translation cache miss may be allowed by the system. Therefore, only those subsequent commands that have translation cache hits (hits under miss), or commands that do not require address translation may be processed while a translation cache miss is being handled. The command getting a translation cache miss must be processed again after address translation entries are retrieved from memory. However, command ordering must still be maintained to ensure that the dependencies between the commands are preserved.

One solution to this problem is to handle only one command at a time. However, as described above, this may cause a serious degradation in performance because commands may be stalled in the pipeline during address translation. Another solution may be to save the state of the command in a buffer in the translation pipeline and insert the command back into the command stream after translation results are retrieved. However, implementing this solution greatly increases complexity of hardware in the system.

Therefore, what is needed is systems and methods for efficiently processing a command after a translation cache miss has been handled.

### SUMMARY OF THE INVENTION

The present invention generally provides methods and systems for processing commands in a command queue.

One embodiment of the invention provides a method for processing commands in a command queue having stored therein a sequence of commands received from one or more input/output devices. The method generally comprises sending an address targeted by a first command in the command queue to address translation logic to be translated and in response to determining no address translation entry exists in an address translation table of the translation logic containing virtual to real translation of the address targeted by the first command in the command queue, initiating retrieval of the address translation entry from memory. The method further comprises processing one or more commands received subsequent to the first command while retrieving the entry for the first command, wherein the processing includes sending an address targeted by a second command in the command queue to the address translation logic to be translated, and reissuing the first command for processing in response to receiving a notification that the address translation entry for the first command is received from memory.

Another embodiment of the invention provides a system for processing commands in a command queue, comprising one or more input/output devices and a processor. The processor generally comprises (i) a command queue configured to store a sequence of commands received from the one or more input/output devices, (ii) an input controller configured to process commands from the command queue in a pipelined manner and reprocess a given command in the command queue in response to receiving a notification signal, and (iii) address translation logic configured to translate virtual addresses to physical addresses utilizing cached address translation entries for a command in an address translation table, and if, for the given command, the address translation entry is not found in cache, retrieve a corresponding address translation entry from memory and assert the notification signal after the address translation entry is retrieved from memory.

Yet another embodiment of the invention provides a microprocessor for processing commands in a command queue. The microprocessor generally comprises (i) a command queue configured to store a sequence of commands from an input/output device, (ii) an input controller configured to process the commands in the command queue in a pipelined manner and reprocess a given command in the command queue in response to receiving a notification signal, and (iii) address translation logic configured to translate virtual addresses to physical addresses utilizing cached address translation entries for a command in an address translation table, and if, for the given command, the address translation entry is not found in cache, retrieve a corresponding address translation entry from memory and assert the notification signal after the address translation entry is retrieved from memory.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is an illustration of an exemplary system according to an embodiment of the invention.

FIG. 2 is an illustration of the command processor according to an embodiment of the invention.

FIG. 3 is a flow diagram of exemplary operations performed by the translate interface input control to process commands in the input command FIFO.

FIG. 4 is a flow diagram of exemplary operations performed by the translate logic to translate a virtual address to a physical address.

FIG. 5 is a flow diagram of exemplary operations performed by the translate interface output control to handle multiple translation cache misses.

FIG. 6 is a flow diagram of exemplary operations performed to flush the pipeline before reprocessing a command causing a miss under miss.

### DETAILED DESCRIPTION OF THE PREFERRED EMBODIMENTS

Embodiments of the present invention provide methods and systems for maintaining command order while processing commands in a command queue while handling translation cache misses. Commands may be queued in an input command queue at the CPU. During address translation for a command, subsequent commands may be processed to increase efficiency. Processed commands may be placed in an output queue and sent to the CPU in order. During address translation, if a translation cache miss occurs the relevant translation cache entries may be retrieved from memory. After the relevant entries are retrieved a notification may be sent requesting reissue of the command getting the translation cache miss.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

An Exemplary System

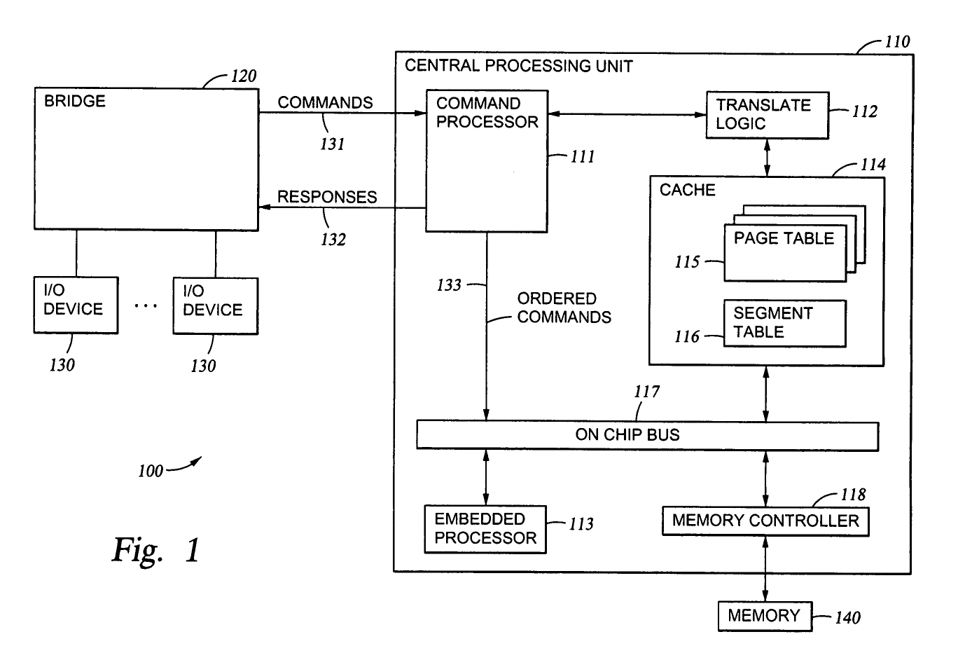

FIG. 1 illustrates an exemplary system 100 in which embodiments of the present invention may be implemented. System 100 may include a central processing unit (CPU) 110 communicably coupled to an input/output (IO) device 120 and memory 140. For example, CPU 110 may be coupled through IO Bridge 120 to IO devices 130 and to memory 140 by means of a bus. IO device 130 may be configured to provide input to CPU 110, for example, through commands 131, as illustrated. Exemplary 10 devices include graphics processing units, video cards, sound cards, dynamic random access memory (DRAM), and the like.

IO device 130 may also be configured to receive responses 132 from CPU 110. Responses 132, for example, may include the results of computation by CPU 110 that may be displayed to the user. Responses 132 may also include write operations performed on a memory device, such as the DRAM device described above. While one 10 device 120 is illustrated in FIG. 1, one skilled in the art will recognize that any number of IO devices 130 may be coupled to the CPU on the same or multiple busses.

Memory 140 is preferably a random access memory such as a dynamic random access memory (DRAM). Memory 140 may be sufficiently large to hold one or more programs and/or data structures being processed by the CPU. While the memory 140 is shown as a single entity, it should be understood that the memory 140 may in fact comprise a plurality of modules, and that the memory 140 may exist at multiple levels from high speed caches to lower speed but larger DRAM chips.

CPU 110 may include a command processor 111, translate logic 112, an embedded processor 113 and cache 114. Command processor 111 may receive one or more commands 131 from IO device 120 and process the command. Each of commands 131 may be broadly classified as commands requiring address translation and commands without addresses. Therefore, processing the command may include determining whether the command requires address translation. If the command requires address translation, the command processor may dispatch the command to translate logic 112 for address translation. After those of commands 131 requiring translation have been translated, command processor may place ordered commands 133 on the on-chip bus 117 to be processed by the embedded processor 113 on the memory controller 118.

Translate logic 112 may receive one or more commands requiring address translation from command processor 111. Commands requiring address translation, for example, may include read and write commands. A read command may include an address for the location of the data that is to be read. Similarly, a write operation may include an address for the location where data is to be written.

The address included in commands requiring translation may be a virtual address. A virtual address may be referring to virtual memory allocated to a particular program. Virtual memory may be continuous memory space assigned to the program, which maps to different, non-contiguous, physical memory locations within memory 140. For example, virtual memory addresses may map to different non-continuous memory locations in physical memory and/or secondary storage. Therefore, when a virtual memory address is used, the virtual address must be translated to an actual physical address to perform operations on that location.

Address translation may involve looking up a segment table and a page table. The segment table and the page table may match virtual addresses with physical addresses. These translation table entries may reside in memory 140. Address translations for recently accessed data may be retained in a segment table entries 116 and page table entries 115 in cache 114 to reduce translation time for subsequent accesses to previously accessed addresses. If an address translation is not found in cache 114, the translations may be brought into the cache from memory or other storage, when necessary.

Segment table entries 116 may indicate whether the virtual address is within a segment of memory allocated to a particular program. Segments may be variable sized blocks in virtual memory, each block being assigned to a particular program or process. Therefore, the segment table may be accessed first. If the virtual address refers to an area outside the bounds of a segment for a program, a segmentation fault may occur.

Each segment may be further divided into fixed size blocks called pages. The virtual address may address one or more of the pages contained within the segment. A page table 115 may map the virtual address to pages in memory 140. If a page is not found in memory, the page may be retrieved from secondary storage where the desired page may reside.

Command Processing

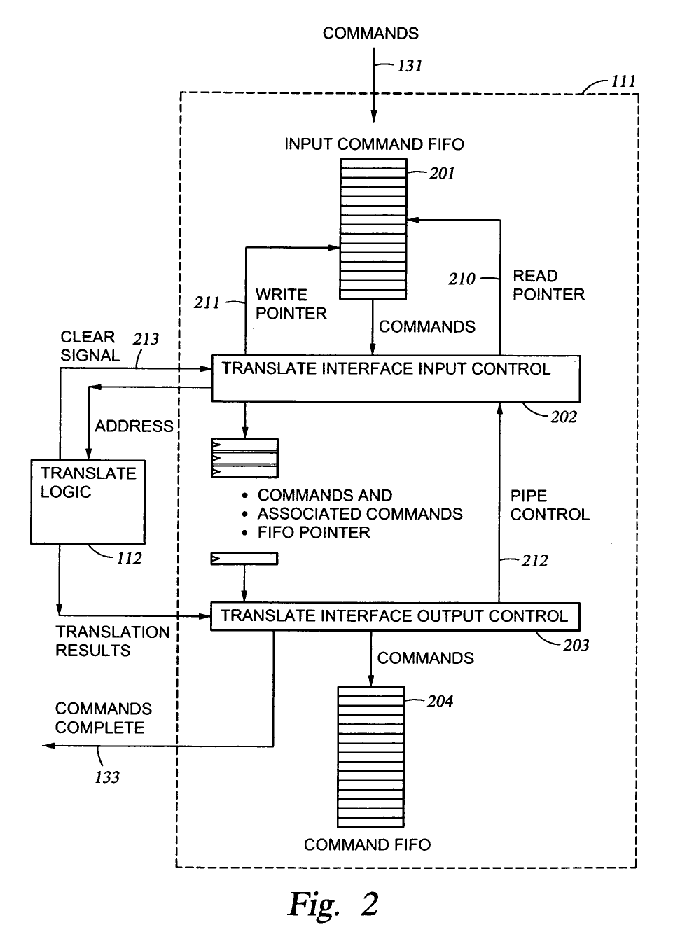

FIG. 2 is a detailed view of the command processor 111 which may be configured to process commands from IO devices 130 according to an embodiment of the present invention. The command processor 111 may contain an input command FIFO 201, a translate interface input control 202, translate interface output control 203 and command FIFO 204. The input command FIFO 201 may be a buffer large enough to hold at least a predetermined number of commands 131 that may be issued to the CPU by IO devices 120. The commands 131 may be populated in the input command FIFO 201 sequentially in the order in which they were received.

The translate interface input control (TIIC) 202 may monitor and manage the input command FIFO 201. The TIIC may maintain a read pointer 210 and a write pointer 211. The read pointer 210 may point to the next available command for processing in the input command FIFO. The write pointer 211 may indicate the next available location for writing a newly received command in the input command FIFO. As each command is retrieved from the input command FIFO for processing, the read pointer may be incremented. Similarly, as each command is received from the IO device, the write pointer may also be incremented. If the read or write pointers reach the end of the input command FIFO, the pointer may be reset to point to the beginning of the input command FIFO at the next increment.

TIIC 202 may be configured to ensure that the input command FIFO does not overflow by preventing the write pointer from increasing past the read pointer. For example, if the write pointer is increased and points to the same location as the read pointer, the buffer may be full of unprocessed commands. If any further commands are received, the TIIC may send an error message indicating that the command could not be latched in the CPU.

TIIC 202 may also determine whether a command received in the input command FIFO 201 is a command requiring address translation. If a command requiring translation is received the command may be directed to translate logic 112 for processing. If, however, the command does not require address translation, the command may be passed down the pipeline.

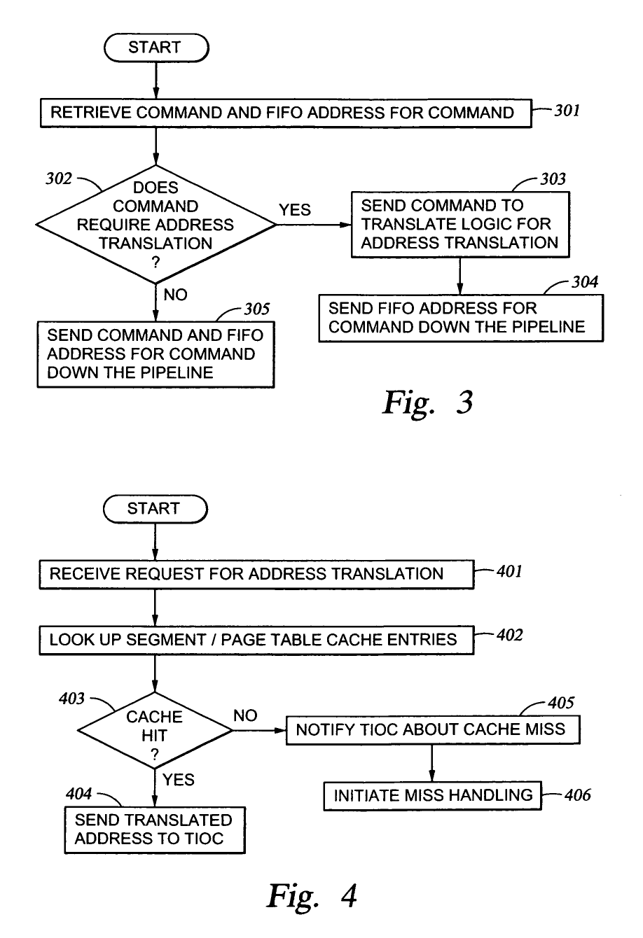

FIG. 3 is a flow diagram of exemplary operations performed by the TIIC to process the commands in the input command FIFO. The operations performed by the TIIC may be pipelined operations. Therefore, multiple commands may be under process at any given time. For example, a first command may be received by the TIIC from the input command FIFO for processing. As the first command is being received, a previously received second command may be sent by the TIIC to the translate logic for address translation.

The operations in the TIIC begin in step 301 by receiving a command from the input command FIFO. For example, the TIIC may read the command pointed to by the read pointer. After the command is read, the read pointer may be incremented to point to the next command. In step 302, the TIIC may determine whether the retrieved command requires address translation. If it is determined that the command requires address translation, the command may be sent to translate logic 112 for address translation in step 303. In step 304, the input command FIFO address of the command sent to the translate logic may be sent down the pipeline. In step 302, if it is determined that the command does not require address translation, the command and the input command FIFO address of the command may be sent down the pipeline in step 305.

Referring back to FIG. 2, the translate logic 112 may process address translation requests from the TIIC. Address translation may involve looking up segment and page tables to convert a virtual address to an actual physical address in memory 140. In some embodiments, the translate logic may allow pipelined access to the page and segment table caches. If a page or segment cache miss is encountered during address translation, the cache may continue to supply addresses for those commands with existing entries while the cache miss is being handled. If no miss occurs during address translation, the translate logic may provide translation results to the Translate Interface Output Control (TIOC) 203, as illustrated in FIG. 2. If however, a miss occurs the translate logic may notify the TIOC about the command causing the miss.

After the address translation for the command getting a miss is retrieved, the translate logic may send a “clear” signal 213 to the TIIC, as illustrated in FIG. 2. In response to receiving the clear signal, the TIIC may reissue the command getting the miss. This time, because the translated address has been retrieved from memory, the command will get a translation cache hit.

If no miss occurs during address translation, the translate logic may provide translation results to the Translate Interface Output Control (TIOC) 203, as illustrated in FIG. 2. If however, a miss occurs the translate logic may notify the TIOC about the command causing the miss.

FIG. 4 is a flow diagram of exemplary operations performed by the Translate logic for address translation. As with the TIIC, the operations performed by the translate logic may be also be pipelined. Therefore, multiple commands may be under process at any given time. The operations may begin in step 401 by receiving a request from the TIIC for address translation for a command. In step 402 the translate logic may access segment and page table caches to retrieve corresponding entries to translate the virtual address to a physical address. In step 403, if the corresponding page and segment table entries are found in the caches, the address translation results may be sent to the TIOC in step 404.

If, however, the page and segment table entries are not found in the segment and page table caches, a notification of the translation miss for the command address may be sent to the TIOC in step 405. The translate logic may initiate miss handling procedures in step 406. For example, miss handling may include sending a request to memory or secondary storage device for the corresponding page or segment table entries. After the miss has been handled, the translate logic may send a “clear” signal to the TIIC in step 407 to indicate that the address translation for the command is now in cache.

Because the command for which an address translation entry is retrieved from memory may not have been processed, such command must be reissued for processing. For example, in some embodiments, in response to receiving the “clear” signal from the translate logic, the TIIC may reissue the command. Because the address translation for the command is now available in cache, the command may get an address translation hit during reissue processing. This simple solution avoids command processing stalls and greatly improves efficiency by allowing commands to be processed while address translation entries for a command getting a translation cache miss are being retrieved. When the address translation entries are available, the command is simply reissued. Furthermore, no additional hardware is necessary to implement the solution, thereby avoiding an increase in hardware complexity.

It is important to note that, for some embodiments, the translate logic may handle only one translation cache miss when there is an outstanding miss being handled. If a second miss occurs, a miss notification may be sent to the TIOC. The handling of a second miss while an outstanding miss is being processed is discussed in greater detail below. Furthermore, as an outstanding miss is being handled, subsequent commands requiring address translation may continue to be processed. Because retrieving page and segment table entries from memory or secondary storage may take a relatively long time, stalling subsequent commands may substantially degrade performance. Therefore, subsequent commands with translation cache hits may be processed while a miss is being handled.

Processing Commands Under Misses

Referring back to FIG. 2, in some embodiments, the TIOC may track the number of outstanding misses being handled by the translate logic and maintain command ordering based on dependencies between the commands. For example, TIOC may receive the input command FIFO address for both, commands sent to the translate logic for address translation, as well as commands not requiring address translation. If commands are received out of order and dependencies exist between commands, the TIOC may retain the commands in command queue 204 and dispatch the commands to the CPU based on their input command FIFO address. FIG. 2 illustrates commands being stored in the command queue 204 by the TIOC. If no dependencies exist, the TIOC may dispatch ordered commands 133 to the CPU, as illustrated.

For example, a first command in the input command FIFO may require address translation and may be transferred to the translate logic for address translation. While the first command is being translated, a subsequent second command depending on the first command that may not require address translation may be passed to the TIOC before translation is complete for the first command. Because of the dependency, the TIOC may retain the second command in the command queue until the translation process for the first command is complete. Thereafter, the first command may be dispatched to the CPU first before the second command. Similarly, while the first command is being translated, a third subsequent command that depends on the first command may get a translation cache hit and be passed to the TIOC. As with the second command, the third command may also be retained in the command queue until the first command is processed and dispatched.

The TIOC may also monitor the number of misses occurring in the translate logic for identifying a miss under a miss. As described above, each time a miss occurs in the translate logic, a notification may be sent to the TIOC identifying the command getting the miss. Because some embodiments allow the handling of only one translation cache miss at a time, if a second miss occurs while a first miss is being handled, the TIOC may stall the pipeline until the first miss has been handled. For example, the translate logic may send a clear signal to the TIIC after a miss has been handled. In response to receiving the clear signal, the TIIC may reissue the command, which may get a hit in the cache, thereby clearing the earlier miss. The TIOC may stall the pipeline until the earlier miss for the command has been cleared before processing of the command causing the second miss can resume. FIG. 2 illustrates a stall pipeline signal 212 sent from the TIOC to the TIIC identifying the command causing the second miss.

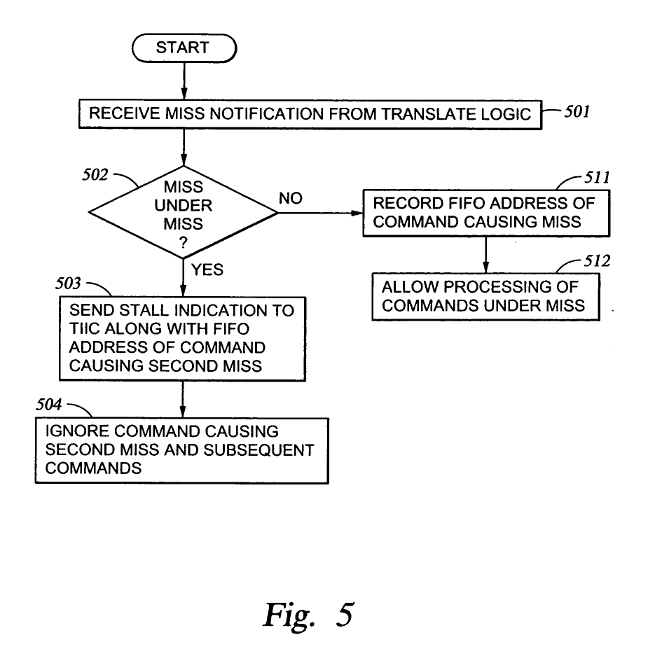

FIG. 5 is a flow diagram of exemplary operations performed by the TIOC to handle address translation misses. The operations begin in step 501 by receiving a miss notification from the translate logic. In step 502, the TIOC determines whether there are any outstanding misses being handled by the translate logic. If no outstanding misses are currently being processed by the translate logic, in step 511, the TIOC records the input command FIFO address of the command. In step 512, the TIOC may allow processing of commands following the command causing the miss, thereby improving performance. If, on the other hand, it is determined that an outstanding miss is being handled in step 502, the pipeline may be stalled. This may be done in step 503 by sending a stall indication to the TIIC along with the input command FIFO address of the command causing the second miss. In step 504, the TIOC may ignore all commands that followed the command causing the second miss. The TIOC may determine these commands by their input command FIFO address.

In response to receiving the stall notification from the TIOC, the TIIC may stall the pipeline by not issuing commands until further notice from the TIOC. The pipeline may be stalled until the first miss has been handled and the translation results are received by the TIOC. The TIIC may also reset the read pointer to point to the command causing the second miss in the input command FIFO. Therefore, the command causing the second miss and subsequent commands may be reissued after the first miss has been handled.

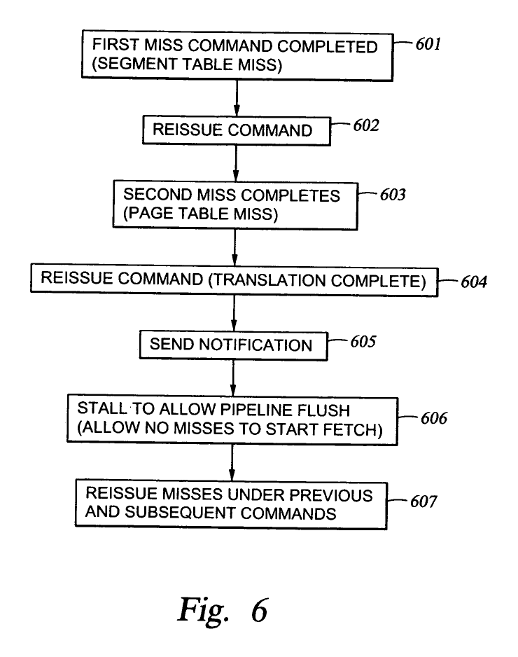

The pipeline may be drained before reissuing a command causing a second miss and subsequent commands. FIG. 6 is a flow diagram of exemplary operations performed to reissue a command causing a second miss after an outstanding translation cache miss has been handled. The operations begin in step 601 by completing the handling of a first miss. The first miss for example may be a segment table miss. After the segment table entries are retrieved, the command may be reissued in step 602.

The command may receive a second miss after reissue. For example, the second miss may be a page table miss. Therefore, in step 603, handling of the second miss hay be completed by retrieving page table entries from memory. After the entries are retrieved, the command may be reissued in step 604.

The address translation may be completed in step 604. Therefore, in step 605, a notification may be sent by the translate logic to the TIOC indicating that address translation for the command is complete. In step 606, the pipeline may be stalled for a predefined period to allow the pipeline to drain. During this time, no misses may be allowed to start fetches from memory.

Thereafter, in step 607, processing of the command causing the second miss and subsequent commands may be resumed. One simple way for resuming processing of the command causing the second miss and subsequent commands may be to reissue previous and subsequent commands getting misses. For example, the TIIC may receive the second command causing the miss and subsequent commands from the input command FIFO and process the commands as described above. Therefore, command ordering is maintained.

### CONCLUSION

By allowing processing of subsequent commands during address translation for a given command and reissuing the given command after the translation results are available, overall performance may be greatly improved. Furthermore, by monitoring address translation cache misses and stalling the pipeline if a miss under miss occurs, embodiments of the invention may facilitate retaining command ordering while handling multiple translation cache misses.

While the foregoing is directed to embodiments of the present invention, other and further embodiments of the invention may be devised without departing from the basic scope thereof, and the scope thereof is determined by the claims that follow.

What is claimed is:

1. A method for processing commands in a command queue having stored therein a sequence of commands received from one or more input/output devices, comprising:
sending an address targeted by a first command in the command queue to address translation logic to be translated;
in response to determining no address translation entry exists in an address translation table of the translation logic containing virtual to real translation of the address targeted by the first command in the command queue, initiating retrieval of the address translation entry from memory;
processing one or more commands received subsequent to the first command while retrieving the entry for the first command, wherein the processing includes sending an address targeted by a second command in the command queue to the address translation logic to be translated; and
reissuing the first command for processing in response to receiving a notification that the address translation entry for the first command is received from memory.

2. The method of claim 1, wherein the commands comprise one of:
commands requiring address translation; and
commands without addresses.

3. The method of claim 1, wherein the command queue is a first in first out queue.

4. The method of claim 1, wherein the address translation table comprises a segment table and a page table.

5. The method of claim 1, further comprising if the address translation entry for the second command is not found in the address translation table, processing the second command and commands following the second command after the address translation for the first command is received.

6. A system, comprising:
one or more input/output devices; and
a processor comprising (i) a command queue configured to store a sequence of commands received from the one or more input/output devices, (iii) an input controller configured to process commands from the command queue in a pipelined manner and reprocess a given command in the command queue in response to receiving a notification signal, and (iii) address translation logic configured to translate virtual addresses to physical addresses utilizing cached address translation entries for a command in an address translation table, and if, for the given command, the address translation entry is not found in cache, retrieve a corresponding address translation entry from memory and assert the notification signal after the address translation entry is retrieved from memory.

7. The system of claim 6, wherein the command queue is a first in first out queue.

8. The system of claim 6, wherein the commands comprise one of:
commands requiring address translation; and
commands without addresses.

9. The system of claim 6, wherein the address translation table is one of a segment table and a page table.

10. The system of claim 6, wherein in response to determining that a command requires address translation, the input controller is configured to send the command to the address translation logic.

11. The system of claim 6, wherein the address translation logic is further configured to:
provide the translated addresses to an output control logic; and
notify the output control logic if a translation for an address is not found in the address translation table.

12. A microprocessor, comprising:
(i) a command queue configured to store a sequence of commands from an input/output device;
(ii) an input controller configured to process the commands in the command queue in a pipelined manner and reprocess a given command in the command queue in response to receiving a notification signal;
(iii) address translation logic configured to translate virtual addresses to physical addresses utilizing cached address translation entries for a command in an address translation table, and if, for the given command, the address translation entry is not found in cache, retrieve a corresponding address translation entry from memory and assert the notification signal after the address translation entry is retrieved from memory.

13. The microprocessor of claim 12, wherein the command queue is a first in first out queue.

14. The microprocessor of claim 12, wherein the commands comprise one of:
commands requiring address translation; and
commands without addresses.

15. The microprocessor of claim 12, wherein the address translation table is one of a segment table and a page table.

16. The microprocessor of claim 12, wherein in response to determining that a command requires address translation, the input controller is configured to send the command to the address translation logic.

17. The microprocessor of claim 12, wherein the address translation logic is further configured to:
provide the translated addresses to an output control logic; and
notify the output control logic if a translation for an address is not found in the address translation table.
